(19) United States
(12) Patent Application Publication
(10) Pub. No.: US 2014/0200982 A1
(43) Pub. Date: Jul. 17, 2014

(54) Dynamic Beneficiary System

(71) Applicants: Kirk Arnold Moir, New Westminster (CA); James Francis Hallett, Vancouver (CA)

(72) Inventors: Kirk Arnold Moir, New Westminster (CA); James Francis Hallett, Vancouver (CA)

(21) Appl. No.: 14/084,612

(22) Filed: Nov. 19, 2013

Related U.S. Application Data
(60) Provisional application No. 61/728,733, filed on Nov. 20, 2012.

(51) Int. Cl. G06Q 30/02

(52) U.S. Cl. CPC G06Q 30/0226
USPC 705/14.27

(57) ABSTRACT

A method and system for the dynamic assignment of benefits to one or more recipients based on rules associated with commerce transactions. Customer purchases goods or services from a merchant. Transaction information associated with the customer and the merchant is received by a central controller. Benefits are credited by the central controller in real time to associated beneficiaries and notifications are transmitted. According to one embodiment, the central controller assigns benefits according to rules specified by the buyer.

### CROSS-REFERENCES TO RELATED APPLICATIONS

This application claims priority from Provisional U.S. patent application Ser. No. 61,728,733, filed Nov. 20, 2012, the disclosure of which is incorporated herein in its entirety by reference for all purposes.

### BACKGROUND OF INVENTION

1. Field of Invention

The present invention relates to systems and methods wherein benefits to one or more recipients are assigned dynamically based on rules associated with transactions.

2. Description of Related Art

A growing percentage of commerce today occurs electronically. This includes commerce conducted in retail locations, goods and services delivered to or at a commercial location or residence, as well as commerce conducted over communications networks such as the Internet.

Electronically enabled commerce typically involves a credit card presented by the customer, a payment processing system such as Visa, Mastercard, Europay, and Discover designed to handle credit card transactions, and a merchant that can accept credit cards and access the payment processing network typically through some form of payment processing or point of sale (PoS) device. Electronically enabled transactions generated at the point of sale are either accepted or refused by the payment processing network based on the credit card credentials presented by the customer.

Debit card based forms of electronically enabled commerce are also typical involving a debit card presented by the customer, a payment processing system from a financial institution and/or a debit card network such Canadian based Interact, Plus, Cirrus, or Cardtronics designed to handle debit card transactions, and a merchant that can accept debit cards and access the payment processing network typically through some form of payment processing or point of sale (PoS) device. Electronically enabled transactions generated at the point of sale are either accepted or refused by the payment processing network based on the debit card credentials presented by the customer.

New forms of payment processing optimized for the unprecedented reach and unique security challenges posed by communications networks such as the Internet have also gained popularity. Payment processing solutions optimized for mobile device form factors such as smart phones and tablets are also gaining popularity. These new forms of payment processing serve to simultaneously increase the percentage of merchants that accept electronic payment and the level of competition in the payment processing industry. Mobile technology such as smart phones is also changing the way credit and/or debit card information is presented to the merchant and the payment processing network by the customer using technologies such as the presentation of 1 and 2 bar codes on high resolution mobile devices displays, near field communications, as well as more network centric approaches involving short range Wireless Fidelity or WiFi, wireless wide area networking (WWAN), or alternative approaches such as Bluetooth.

A key consideration for merchants increasingly reliant on electronically enabled commerce is the enablement of loyalty. Loyalty and gift cards also known as stored or associated value cards are also becoming widely used. Loyalty and gift cards are provided by a specific merchant for use in their location or locations. Value is loaded via a cash or non cash transaction using debit or credit cards either at a merchant location via some electronic means such as the Internet. Some merchants provide electronic means to either manually or automatically reload the stored or associated value card. Merchants are also using mobile technology to enable mobile devices such as smart phones to act as the stored value card or loyalty cards where the amount of value is stored in the “cloud” on a computer connected to the Internet.

In order to attract customers and transaction traffic, providers of debit and credit card systems offer various transaction based incentive programs either developed internally or offered by a third party provider. These incentive programs typically provide some form of credits or points which are provided proportionally to the size of the transaction. Some incentive programs may provide time limited programs where more points are assigned for purchasing a certain kind of good or service or purchasing at a certain class of merchant. Wide varieties of other incentive schemes exist or are possible.

Points from such incentive or loyalty programs may be redeemed for goods or services at merchants who supply the incentive program provider. The number of points required to redeem a certain item may vary from time to time. Some incentive programs allow incentive program points to be transferred to third parties deemed a worthy recipient by the customer who earned the points originally through their purchases.

While many such incentive programs are in active use, customers face have substantial choice in credit, debit, and store valued card based programs with associated loyalty or incentive based features. As a result, fostering long term loyalty, the ultimate objective of any transaction based incentive program, has proven difficult. A major deficiency faced by such incentive programs is the significant delay in realizing the associated incentive.

In order to improve the loyalty performance of transaction based incentive programs, an improved system would be useful for enabling the consumer to design their own incentive program in advance based on their specific interests and preferences enabling a substantial reduction in the realization of reward.

One solution is to provide an accelerated level of incentive to the customer based on transaction volume over some period of time. While potentially an effective incentive for the provider of the credit, debit, or store value card, funding the increased cost of the incentive is a significant economic challenge.

### SUMMARY OF THE INVENTION

The present invention integrates electronic payment processing with a dynamic benefits accumulation capability.

It is an object of the present invention to provide new and improved systems and process which preferably utilize enabling technologies to implement an electronic payment process favorable to both a customer and a merchant.

In accordance with the present invention, there is provided a system and process which enables an electronic payment processing system to effectively allow a customer to design their own rewards program allocating the benefits or rewards associated with each payment transaction. Effectively, the current invention establishes systems and methods for enabling a customer to proceed rewards or benefits to 1 or more beneficiaries of the choice on a per payment transaction basis.

The central controller or processor can be run by a merchant, a collection of merchants, or by a third party providing new or existing electronic payment system capabilities. When the customer pays for a good or service electronically at the merchant's location, another location such as the customer's premise, or over some communications network such as the Internet, the customer's payment credentials along with information associated with the purchase transaction is transmitted through some combination of wired and wireless networks to the Central Controller which allocates rewards or benefits according to rules specified by the customer as well as other rules established by operator of the electronic payment system or the merchant involved in the purchase.

Accordingly, one aspect of the present invention enables customers to become registered with the electronic payment system either through some form of online application process, some preexisting registration process including online process, offline or paper based non-electronic process or some combination of all of these possible process configuration. Customers that have registered can then specify rules for allocation of rewards or benefits associated with a specific transaction or transaction type to one or more beneficiaries.

Accordingly, another aspect of the present invention enables beneficiaries to become registered with the electronic payment system either through some form of online application process, some preexisting registration process including online process, offline or paper based non-electronic process or some combination of all of these possible process configuration. Beneficiaries that have registered with the system are subject to some form or automated approval process, approval process involving manual processing or some combination of the two. Once a beneficiary is approved, it becomes available to all or some appropriate portion of the customers who can allocate all or a portion of the benefits or rewards provided to them by the merchant and/or the payment processing system to one or more approved beneficiaries.

Accordingly, another aspect of the present invention enables the electronic payment processing system to calculate and accrue benefits or rewards associated with each processed purchase transaction according to the rules specified by the customer involved in the purchase transaction as well as rules associated with the merchant involved in the purchase transaction as well as other system rules. The amount of benefit or reward associated with any given purchase may also be subject to rules established by the overall system or the merchant involved in the transaction or both. This accrual of benefits can apply to merchant specific electronic payment processing systems, payment processing systems associated with a collection of merchants, with a new electronic payment processing system or with an existing payment processing system.

Accordingly, another aspect of the present invention enables the electronic payment processing system to provide notification of rewards or benefits to the customer, merchant, or assigned beneficiary or beneficiaries on either a per transaction basis, a periodic basis, or via some threshold enabled basis according to the specification provided by each of those parties. Notification may occur via electronic means such as email, text message, facsimile, voicemail, other form of voiced based notification, notification the website of the central controller or some third party website or media service. Notification can also be occur in non electronic form such as mail. Notification in this context includes both notification as well as availability of the information for query purposes.

Accordingly, another aspect of the present invention enables the electronic payment processing system to provide delivery of accrued benefits or rewards to beneficiaries receiving rewards. In the case of monetary rewards, such a delivery is similar to the settlement process whereby an electronic payment system transfers funds to merchants in the amount totaling the sum of all owing payments over some period of time such as a day, week, month or quarter. Such delivery can also occur on a per transaction basis. Monetary based rewards can be delivered electronic or via some paper form of transfer such as a check or money order delivered via mail, courier, or in person. Delivery or notification of non-monetary rewards would be delivered via electronic means such as email, facsimile, or file transfer or via some non-electronic paper form delivered to the beneficiary in some form such that the beneficiary can redeem the reward or benefit.

In one embodiment, a community consisting of customers, merchants, and third party beneficiaries such as community groups, charities, and sports teams work together to develop an alternative, locally focused payment system consisting of some form of stored value debit system focused on a specific community or locality. Incentive benefits are assigned by the merchants individually and/or as a group of merchants to purchases made by customers. An example of such an incentive benefit defined by the merchant is 1% of the purchase amount. This incentive benefit associated with a purchase made by a specific customer is assigned to one or more third party beneficiaries that have registered with the system according to rules specified by the customer. An example of this is as follows: a customer purchases of $100 of goods. The associated merchant makes 1% or $1 available to the customer as an incentive benefit. The customer has specified in the system that 50% of any benefits received go to the local football team and 50% of any benefits received go to the local foodbank. The system is responsible for tracking of all customers, merchants, beneficiaries, benefit rules, purchases, benefit assignments, and records of funds received from and/or sent to customers, merchants, as well as beneficiaries. Depending on the jurisdiction, the system can also automate the generation of information required by the customer, merchant and/or beneficiary for tax purposes. FIG. 11.

There is disclosed a method of conducting business among a group of merchants, a customer and a beneficiary, comprising the steps of: a) a plurality of merchants forming a local group who agree with a customer to respect a card that has monetary or equivalent value that is usable to purchase the goods or services of said merchants; b) customer designating one or more beneficiaries; and c) customer making a purchase from one merchant from said group, by using said merchant card value, and allocating a portion of said value that is sent automatically by said merchant to said beneficiaries, said portion being the difference between the transaction cost normally charged by a third-party credit card processor for that transaction and the actual transaction cost of using said card. Also, there is disclosed the said method wherein said card is issued by said group of merchants. Also, there is disclosed the said method wherein said card is issued by a financial institution. Also, there is disclosed the said method wherein said card is a credit card issued by a financial institution, and customer use of said credit card is associated with the value of the grant of “loyalty” points respected by said group of merchant. Also, there is disclosed the said method wherein said card is a debit card issued by a financial institution, and customer use of said debit card is associated with the value of the grant of “loyalty” points respected by said group of merchant. Also, there is disclosed the said method wherein said card is a “stored value” card wherein customer use of said card is associated with “loyalty” points respected by said group of merchant. Also, there is disclosed the said method wherein said card is a gift card denominated in monetary currency.

### BRIEF DESCRIPTION OF DRAWINGS

FIG. 1. illustrates the context of the dynamic beneficiary system.

FIG. 2. illustrates the system architecture of the dynamic beneficiary system.

FIG. 3. is a functional block diagram of a typical prior art point of sale device.

FIG. 4. is a block diagram of the logic server aspect of the central controller

FIG. 5. is a block diagram of the database server aspect of the central controller

FIG. 6. is a logic diagram illustrating the process of customer signup and beneficiary program specification

FIG. 7. is a logic diagram illustrating the process of beneficiary signup, screening and

FIG. 8. is a logic diagram showing the steps implemented when a customer initiates a payment transaction which may result in immediate accumulation of benefits

FIG. 9. is an example screen showing a possible embodiment of how a customer might be prompted for benefit allocation rules

FIG. 10. is an example screen showing a possible embodiment of how a third party beneficiary might request

FIG. 11. is a high level data flow diagram of one described embodiment of a system implementing this invention.

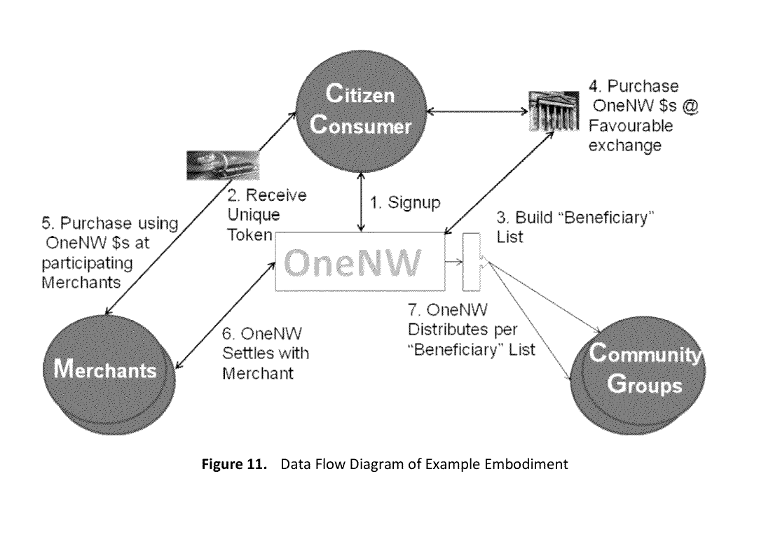

### DETAILED DESCRIPTION OF THE INVENTION

In this section, the present invention is described in detail with regard to the drawing figures briefly described above.

Accordingly, the following terms are used through the remainder of this section. For purposes of description such terms shall have the following means:

The terms “merchant”, “store”, “outlet”, and “retailer” unless otherwise specified below are used interchangeably to refer to any type of location that sells goods or services and process electronically enabled payment transactions from customers. The terms include both physical as well as remote (e.g. catalog or Internet) sellers who process transactions that enable the present invention.

The terms “good”, “item”, “service” and “product” unless otherwise specified below, are used interchangeably to refer to any type of commodity that may be sold by a merchant and paid for by a customer using some form of electronically enabled payment. It should be readily appreciated that both products and services may be sold by merchants in this manner.

The terms “customer”, “buyer”, and “consumer” unless otherwise specified below, are used interchangeably to refer to any party that initiates a purchase of a good or a service. It should be readily appreciated that customer may be physically present at a merchant location, at another location were representatives of the customer and the merchant are present such as the customer's home or work site or at some remote location using some form of communications technology to interact with the merchant.

The terms “benefit” and “reward” unless otherwise specified below, are used interchangeably to refer to any amount of value other in monetary or in some other form of value such as in kind good or service that is associated with a payment transaction. The benefit is provided by the merchant via the electronic payment system to the customer in exchange for their patronage and associated loyalty.

The terms “beneficiary”, “third party”, “charity”, and “community group” unless otherwise specified below, are used interchangeably to refer to any party that has applied to receive some sort of benefit or donation in the form either in monetary or non-monetary form as the result of a transaction between a merchant and a customer in which the customer has designated which third parties it wishes to receive some portion of the benefit associated with the transaction as specified by the merchant and/or the electronic payment processing system. A beneficiary can be an individual or an organization of some form including for profit and non-profit entities.

The terms “credit card”, “debit cards”, and “customer payment credentials”, “customer identifier”, “ACH (Automated Clearing House) direct debit” unless otherwise specified below, are used interchangeably to refer to encompass debit cards and any other form of credit, debit or stored value used to make a purchase by providing either in physical or electronic form using a unique reference number which uniquely identifies a customer's account from which funds used to pay for the good or service purchases.

The above defined terms are used through this section to describe the preferred embodiment of the present invention in reference to the attached drawing figures. Where appropriate, parts are referred to with reference numerals.

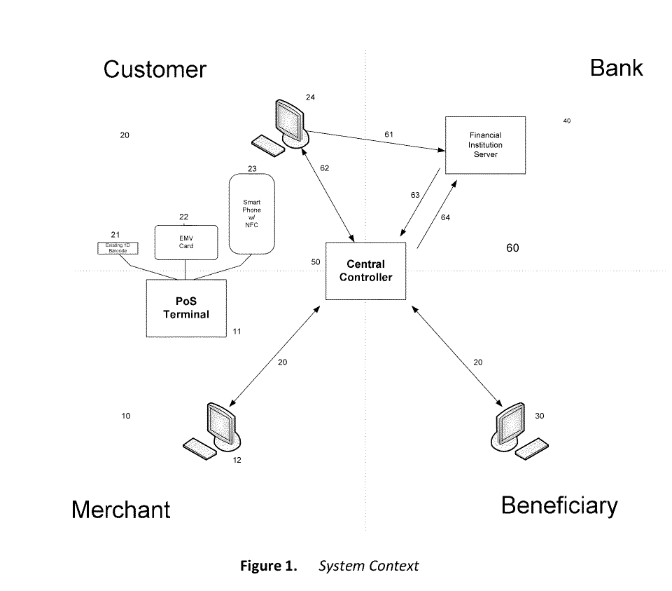

Referring to FIG. 1., the principal components used to implement the present invention are illustrated in a block diagram. At the lower left of the Figure, the dashed lines depict the merchant's point of sale location 10 which can be a fixed store front with a single point of sale area or station, a larger store with multiple point of sale stations, a virtual location accessed over the Internet, or a mobile location with one or more point of sale stations. At the merchant location 10, one or more point of sale terminals 11 are deployed to accept some form of electronic point. Merchants also have the optional ability to interact with the Central Controller using a computer of some form such as a laptop or tablet 12 via a communications interface 65 such as the Internet to create or change their account profile or to view information about the transactions sent from their location or possibly multiple locations.

Continuing with reference to FIG. 1, the customer and in particular the customer's form of identification is depicted 20. The customer has one or more of a plethora of possible forms of identification. These include bar code identification 21, magnetic strip or more sophisticated “chip” or EMV (for Eurocard, Mastercard, Visa) cards 22, or some form of personal digital assistance device or smart phone 23 such as a Samsung Galaxy or an Apple iPhone 5 with associated identification technology such as near field communications (NFC) such as Google Wallet, 1 dimension bar code show on the screen or similarly a 2 dimension bar or QR code show on the screen. Starbucks mobile application including version 2.0.2 for Android and Apple's Passport application are example of this. Customers also have the optional ability to interact with the Central Controller using a computer of some form such as a laptop or tablet 24 via a communications interface 62 such as the internet to create or change their account profile or to view information about the transactions they have originated.

Continuing with reference to FIG. 1, a unique element is introduced into the standard electronic payment processing environment. With advances in information technology, third parties or beneficiaries can become significant entities to be managed by the Central Controller. In FIG. 1, an example third party or beneficiary and in particular the third party's ability to interact with the Central Controller via a computer of some form such as a laptop or tablet is depicted 30. Third parties have the ability to signup to receive benefits via the interface depicted as 66 in the figure and, upon passing an eligibility test performed completely by the Central Controller or completely by a human operator or by some combination of the two, be available for customers to include in the design of their benefits or rewards plan.

Continuing with reference to FIG. 1, the Bank or other financial institution and in particular their electronic transaction management capability such as the Financial Institution Server is depicted at 40. The financial institution may support credit, debit, stored value or other loyalty related card transactions as is typical of electronic payment systems. Links 61 63 and 64 are data communications lines and are configured to allow for data communications between the Central Controller 50 and the financial institution and the Customer. Optionally, the customer may communicate directly with the financial institution either in person, via telephone or via some internet communications enabled means depicted as interface 61 in the figure to instruct the financial institution to forward funds electronically to the Central Controller as is typical of stored or associated value cards using interface 63. Optionally, the Central Controller can request approval and transfer of funds on a per transaction basis using interfaces 63 and 64 as is typical of credit and debit card transaction processing within a typical electronic payment system.

As will be seen, the structural elements and arrangement of the system 60 enable a new electronic payment paradigm. In particular, the system 60 allows a customer through a computer 24 to design their own rewards systems based on approved third party beneficiaries. Rewards or benefits are accumulated on a per transaction base for display and/or notification to merchants, the transacting customer, other approved customers or users who have subscribed for this information, the receiving third party or other approved third parties.

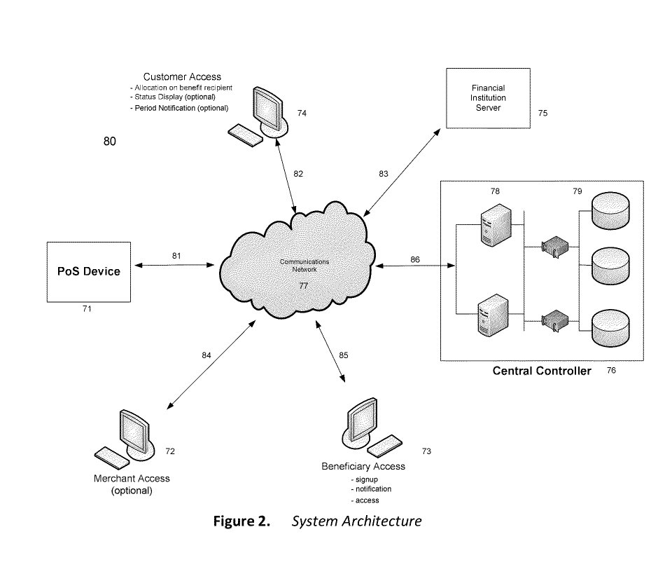

Referring to FIG. 2. the architecture of the system is illustrated as a block diagram in which a point of sale electronic payment terminal 71 such as a Verifone Vx 510, Ingenico ML30 or new electronic payment terminals utilizing commercial off the shelf mobile devices like the Apple iPhone with accessories and software from suppliers such as Paypal is attached by some form of communications capability including some combination of Cable modems, DSL, DS1, DS3, SONET, Ethernet, fiber optic, WiFi 802.11 or other wireless technology such as CDMA, GSM or long term evolution (LTE) or other future communications capability 81 to a communications network 77 such as the Internet. As depicted in FIG. 1, various forms currently available as well as future forms of uniquely identifying the customer for purposes of initiating an electronic payment transaction are expected to be presented to the point of sale electronic payment terminal. These include plastic cards with a 1 or 2 dimension bar code, magnetic strip cards and “chip” cards, or some form of personal digital assistance device or smart phone 23 such as a Samsung Galaxy or an Apple iPhone 5 with associated identification technology such as near field communications (NFC), 1 dimension bar code show on the screen or similarly a 2 dimension bar or QR code show on the screen.

Continuing with reference to FIG. 2, the computer 73 of some form such as a laptop such as an Apple MacBook Air or tablet such as a Google Nexus 7 used by the third party or beneficiary to interact with the Central Controller 77 is depicted. The third party's computer 73 is connected by some form of communications capability including some combination of Cable modems, DSL, DS1, DS3, SONET, Ethernet, fiber optic, WiFi or other wireless technology such as CDMA, GSM or long term evolution (LTE) or other future evolutions 85 to a communications network 77 such as the Internet and via the communications network to the Central Controller 76. It should be appreciated that the third party or individuals associated with a third party organization could use different computers at different times to access the Central Controller 76 via the communications network 77.

A computing device 72 of some form such as a laptop or tablet used by the merchant to interact with the Central Controller 76 is depicted. This computer 72 is connected by some form of communications capability including some combination of Cable modems, DSL, DS1, DS3, SONET, Ethernet, fiber optic, WiFi or other wireless technology such as CDMA, GSM or long term evolution (LTE) or other future evolutions 84 to a communications network 77 such as the Internet and via the communications network to the Central Controller 76. It should be appreciated that a merchant or individuals associated with a merchant organization could use different computers at different times to access the Central Controller 76 via the communications network 77.

Similarly, a computing device 74 of some form such as a laptop or tablet used by the customer to interact with the Central Controller 76 is depicted. This computer 74 is connected by some form of communications capability including some combination of Cable modems, DSL, DS1, DS3, SONET, Ethernet, fiber optic, WiFi or other wireless technology such as CDMA, GSM or long term evolution (LTE) or other future evolutions 82 to a communications network 77 such as the Internet and via the communications network to the Central Controller 76. It should be appreciated that a customer could use different computers at different times to access the Central Controller 76 via the communications network 77.

Continuing with reference to FIG. 2, the Central Controller 76 is connected via some form of communications capability including some combination of Cable modems, DSL, DS1, DS3, SONET, Ethernet, fiber optic, WiFi or other wireless technology such as CDMA, GSM or long term evolution (LTE) or other future evolutions 86 to a communications network 77 such as the Internet. The communications network 77 and the Central Controller 76 are capable of handling a high rate of transactions include payment transactions from merchants as well as query and update transactions from customers, merchants, and third parties.

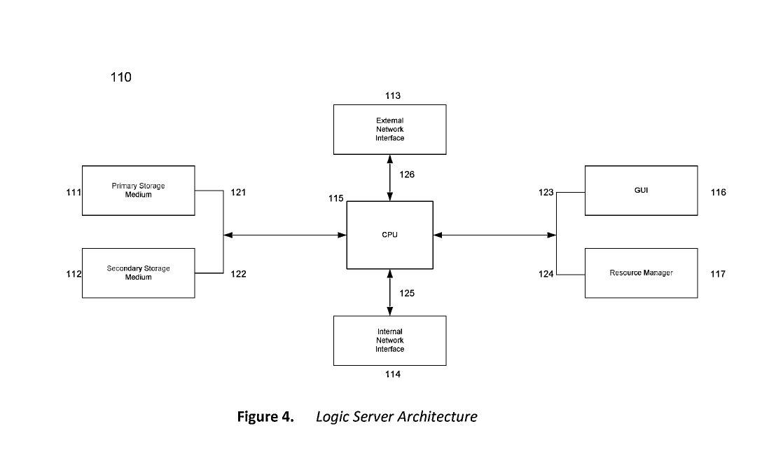

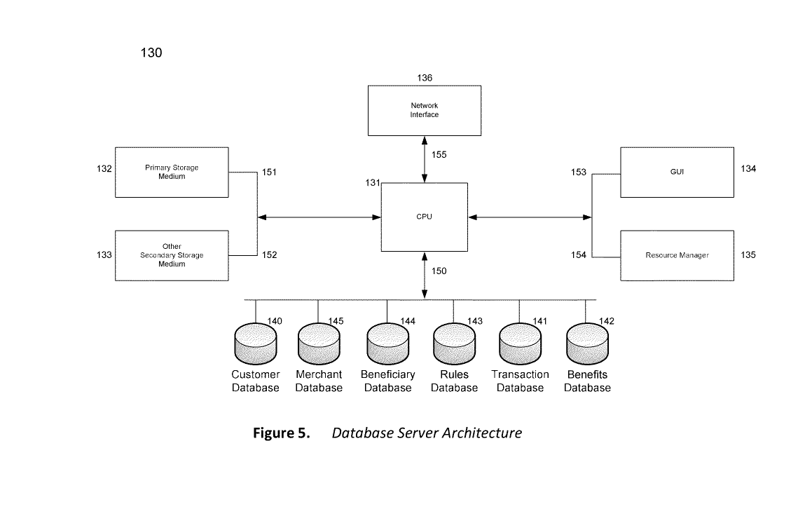

The Central Controller 76 consists of two major aspects. These are the Logic Server 78 and Database Server 79. The Logic Server aspect of the Central Controller contains the business logic for managing the transaction according to rules defined by the payment processing system operator as well as the rules defined by the customer describing the manner in which they would like to see their benefits or rewards distributed to third parties that have met the requirements established by the payment processing system operator. The Logic Server is described in more detail in FIG. 4. The Database Server aspect of the Central Controller provides the storage and synchronization of data associated with customers, merchants, transactions, third parties, system and beneficiary rules, as well as benefits accumulations and associated payments to merchants and third parties as well as customers when appropriate. The Database Server is described in more detail in FIG. 5.

The component parts forming the system 80 will be readily understood by those skilled in the area of electronic payment processing systems and information technology. Accordingly, for purposes of brevity, detailed discussions of such component parts are omitted.

The aforementioned discussions about the structure and operations of system 80 make clear that a customer presenting some form of electronically readable identification that can be read by the payment processing terminal 71 is now actively connected to the benefits that the transaction performed will generate thereby increasing loyalty between the customer and the merchant who is responsible for sharing this benefit with the third party or third parties designated by the customer. The customer may choose to have different third parties designated based on some criteria such as merchant, geographic location, time of day, week or month, or based on amount of previously generated benefits or by the amount of benefit received by a designated third party. The merchant may also choose to accelerate or enhance the transactional benefit to a third party that he may choose to support for a specific period of time. For example, during a fund raising period of a soccer club, a local merchant may match the benefit amount based on purchases from customers who have assigned benefit to that specific soccer club.

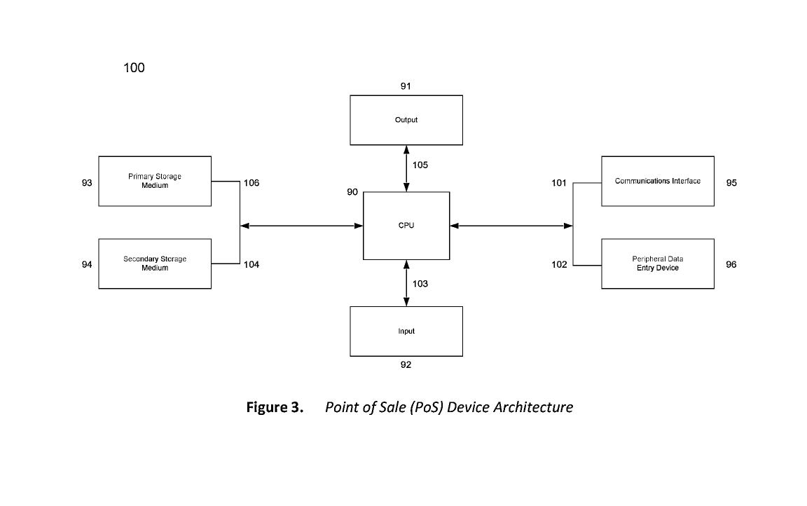

Referring to FIG. 3. a point of sale electronic payment processing terminal is depicted in accordance with the definitions provided above in more detail. The point of sale electronic payment processing terminal includes a central processing unit (CPU) 90 to execute instructions which are delivered or installed electronically (software) to the terminal such as a client program to manage the operation of terminal. An input device 92 of some form is provided that connects with the CPU 90 via some form of connectivity 103. Various forms of input device are possible and multiple input devices may be built into the same payment processing terminal. Input forms are varied and evolving rapidly including include 1 and 2 dimensional bar code reader which can read bar codes imprinted on a plastic card or piece of paper or be displayed on the screen of a mobile device, magnetic strip reader, chip reader, near field communications reader or other forms of wireless readers are possible. Bio metric readers such as finger print readers, facial recognition cameras, or human eye readers may be used as standalone input methods or in conjunction with other input methods. The input device or devices(s) can be directly attached to the payment processing terminal or be attached via some combination of data input devices 96 via wired or wireless networking technology 102 such as Ethernet, Bluetooth, or WiFi. It should be appreciated that input forms will evolve to provide higher levels of security, performance, and convenience to both the customer and the merchant. An output device 91 is connected to the CPU via some form of connectivity 105 to display relevant information relevant to the specific operation or transaction performed by the installed software. There may be multiple output devices attached to the CPU either displaying the same information or a portion of the information that is relevant to the merchant and a portion that is relevant to the customer. A primary storage mechanism 93 is coupled to the CPU by interface 106 and is used to temporarily store instructions as well as input and output data. The CPU is also coupled by interface 104 a secondary storage medium which is used to store permanently even when the terminal is not powered instructions and relevant information such as configuration parameters. The terminal is also coupled via interconnection 101 to a communications interface device 95 to attach to the communications network 77 of FIG. 2. by some form of communications capability including some combination of Cable modems, DSL, DS1, DS3, SONET, Ethernet, fiber optic, WiFi 802.11 or other wireless technology such as CDMA, GSM or long term evolution (LTE) in a manner well known to those skilled in the area of electronic payment processing systems and communications technology.

Referring to FIG. 4. The logic server aspect of the central controller is depicted in accordance with the definitions provided above in more detail. The logic server aspect of the central controller 110 includes 1 or more central processing units (CPU) 115 to execute instructions which are delivered or installed electronically (software) to the logic server such as a server program to manage the operation of system. For the purposes of system administration including system activity and status review, capacity optimization, or system configuration among other functions, a graphic user interface (GUI) 116 of some form is optionally provided that connects with the CPU 115 directly via some form of connectivity 123 or optionally via the Internal Network Interface 114 or securely via the External Network Interface 113. Optionally, a Resource Manager device 117 of some form is connected to the CPU 115 directly via some form of connectivity 124 or optionally via the Internal Network Interface 114 or securely via the External Network Interface 113. A primary storage mechanism 111 is coupled to the CPU by interface 121 and is used to temporarily store instructions as well as input and output data. The CPU is also coupled by interface 122 to a secondary storage medium which is used to store permanently even when the Logic Server 110 is not powered instructions and relevant information such as configuration parameters. The Logic Server 110 and in particular the CPU 115 is also coupled via interface 126 to some form of to an external communications interface 113 to attach to the communications network 77 of FIG. 2. in a manner well known to those skilled in the area of electronic payment processing systems and communications technology. The CPU 115 of the Logic Server 110 is also coupled via interface 125 to an internal communications interface 114 to attach to other element of the Central Controller include redundant instances of the Logic Server and one or more instances of the Database Server aspect of the Central Controller in a manner well known to those skilled in the area of information systems and communications technology.

Referring to FIG. 5. The database server aspect of the central controller is depicted in accordance with the definitions provided above in more detail. The database server aspect 130 of the central controller includes 1 or more central processing units (CPU) 131 to execute instructions which are delivered or installed electronically (software) to the logic server such as a server program to manage the operation of system. For the purposes of system administration including system activity and status review, capacity optimization, or system configuration among other functions, a graphic user interface (GUI) 134 of some form is optionally provided that connects with the CPU 131 directly via some form of connectivity 153 or optionally via the Network Interface 136. Optionally, a Resource Manager device 135 of some form is connected to the CPU 131 directly via some form of connectivity 154 or optionally via the Network Interface 136. A primary storage mechanism 132 is coupled to the CPU 131 by interface 151 and is used to temporarily store instructions as well as to input and output data. The CPU is also coupled by interface 150 to databases used to persistently store information about the status of the overall system. Database 140 stores information about the customers registered including some optimal combination of their name, contact information, security credentials, and possible bio metric information. Database 145 stores information about the merchants registered including some optimal combination of their name, contact information, security credentials, and possible bio metric information. Database 144 stores information about the third party beneficiaries registered including some optimal combination of their name, contact information, security credentials, and possible bio metric information. Database 141 stores information about transactions processed including some optimal combination of their time, date, customer identifier, merchant identifier, location identifier and/or coordinates, amount, type, and possible security credentials. Database 142 stores information about benefits awarded including some optimal combination of their date, time, customer identifier, merchant identifier, third party beneficiary identifier, transaction identifier, and possible security credentials. Database 143 stores information about the system and customer defined benefits rules for allocating benefits or awards to third party beneficiaries as customers generate transactions with merchants for goods or services. The Rules Database 143 including some optimal combination of customer identifier, beneficiary identifier, transaction allocation amount and possible security credentials. The CPU is also coupled by interface 152 to other secondary storage medium 133 which is used to store permanently even when the Database Server 130 is not powered instructions and relevant information such as configuration parameters. The databases 140, 141, 142, 143, 144, 145, and other Secondary Storage Medium 133 are connected and configured for optimal systems operation in a manner well known to those skilled in the area of information systems and database technology. The Database Server 130 and in particular the CPU 131 is also coupled via interface 155 to some form of to a communications interface 136 to attach other aspects of the system including the Logic Server aspect of the Central Control via the internal network interface 114 of FIG. 4. in a manner well known to those skilled in the area of information systems and communications technology.

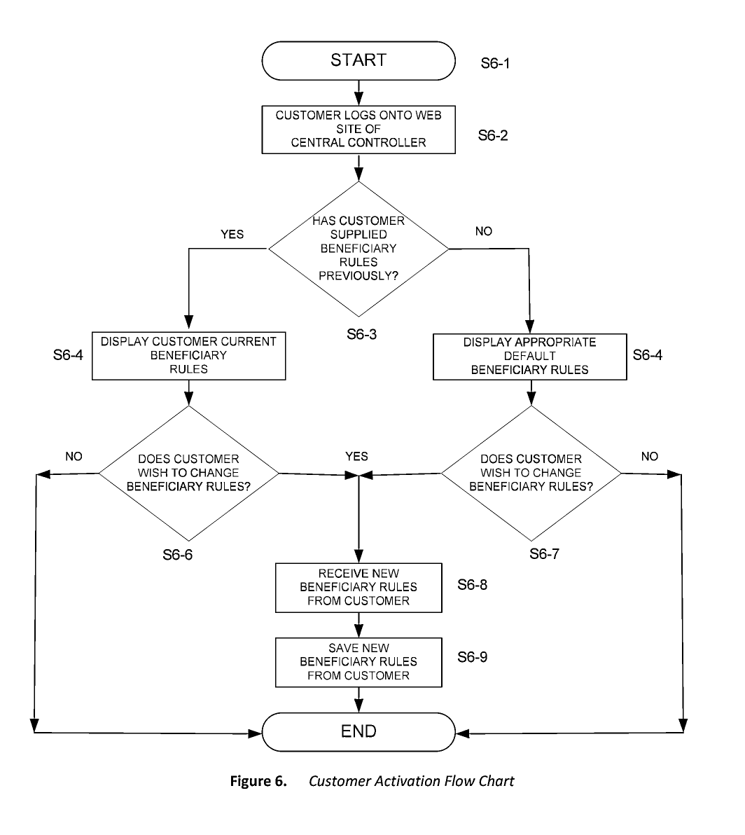

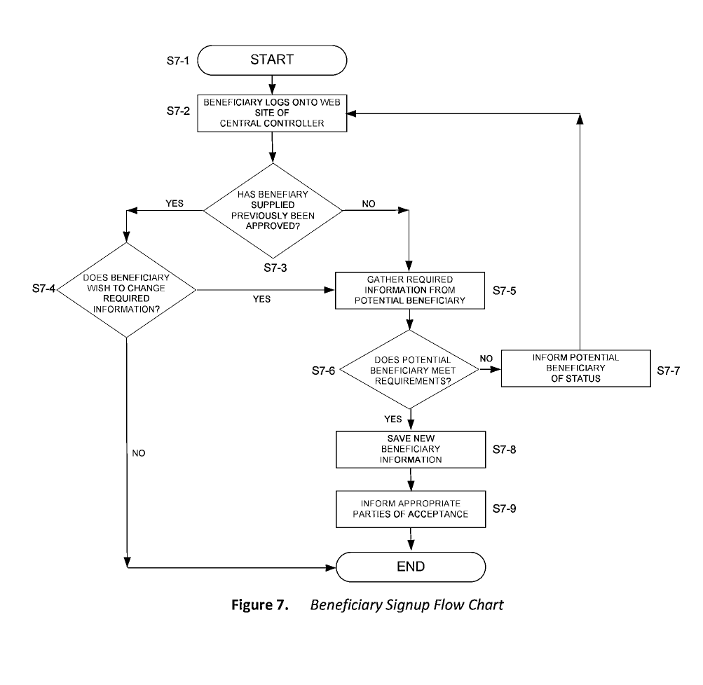

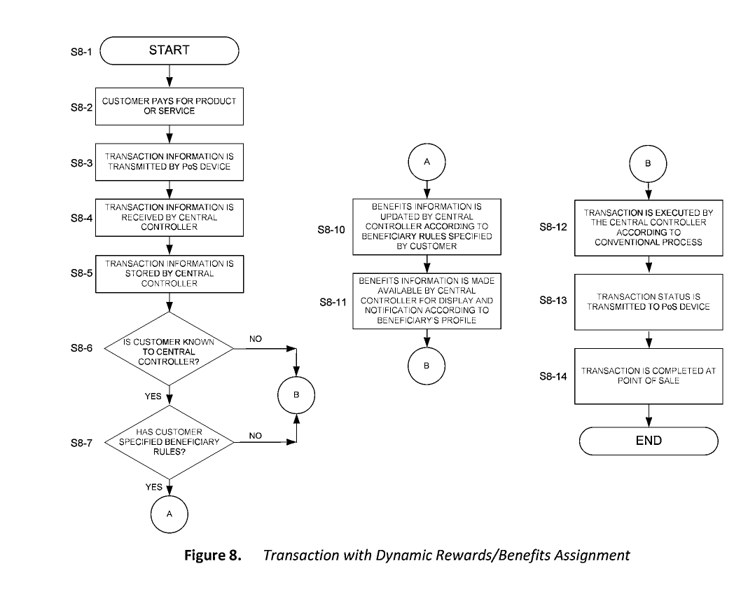

Referring to FIG. 6, FIG. 7 and FIG. 8. depicted therein are a series of flowcharts that illustrate the salient steps of the preferred process for allowing a system such as system 60 to enable customers to design their own rewards benefits rules enabling customers to automatically reward selected third party beneficiaries on a per transaction basis which transactions are processed by an electronic payment processing system. Many of the steps depicted in these figures illustrate the sequence of operations carried out by the transaction processing system embodied by a central controller such as the central controller 76 depicted in FIG. 2. The software programming necessary to carry out the functions stated below will be readily apparent to those skilled in the art of software development. Additionally, the use of Internet enabled technologies enabling web based and mobile based data entry as well as query and display of information optimized for web and mobile display which will be readily apparent to those skilled in the art.

With reference to FIG. 6, a flowchart describing the steps used to register and activate a customer is illustrated. Processing starts at S6-1 and immediate proceeds to Step S6-2 where a customer logs onto the website served by a central controller using web browser software such as Google Chrome or Internet Explorer. In an alternate embodiment, the customer may register or may have registered by some alternative process that gathers all or some of the required information. Examples of alternative processes include paper forms, customer interviews and related data entry by a customer service representative, as well as alternative system access using credentials and related customer information supplied to an alternative website such as Facebook or LinkedIn.

After accessing the central controller, the customer supplies information included by not limited to unique identifier which may be entered manually or presented automatically by device the customer is using to access the central controller, name, email address, other alternative contact information such as residence address, social media identifiers, and telephone number or numbers which are stored in the Customer database 140.

Proceeding to step S6-3, the system determines if the customer that has logged in has previously supplied third party beneficiary rules. If the customer has previously provided third party beneficiary rules, these are displayed to the user at step S6-5. In an alternative embodiment, the system detects the type of device the customer is using to access the system and optimizes the format of the information for display on this type of device. If the customer has not previously provided third party beneficiary rules, the system displays the appropriate default set of beneficiary rules at step S6-4. Similar alternative embodiments are possible.

Proceeding to step S6-6, in the event the customer has previously supplied third party beneficiary rules, the customer is prompted to determine if changes to the specified set of rules are desired. If the event changes are desired, new rules are received from the user at step S6-8 and are saved into the rules database at step S6-9.

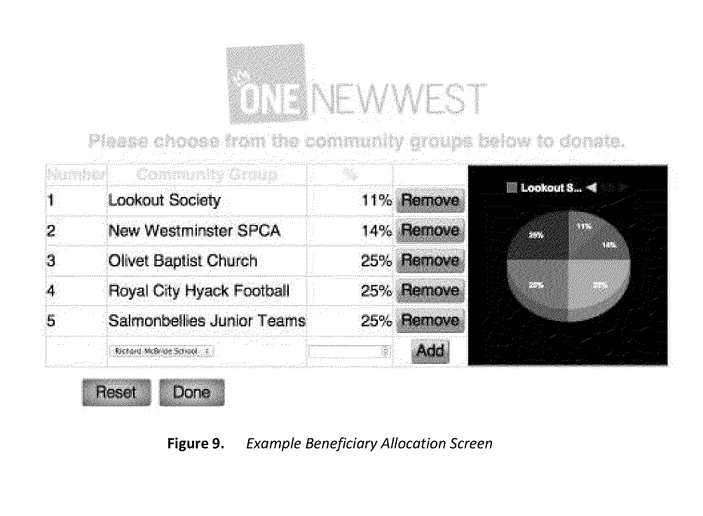

Proceeding to step S6-6, in the event the customer has not previously supplied third party beneficiary rules, the customer is prompted to determine if changes to the default set of rules are desired. If the event changes are desired, new rules are received from the user at step S6-8 and are saved into the rules database at step S6-9. In one embodiment, the customer specifies percentages of the benefit to be allocated to one or more approved beneficiaries. An example of this user interaction is provided in FIG. 9. In an alternative embodiment, the customer can chose to allow some portion of the benefits or rewards associated with all or some portion of their transactions based on some criteria to remain allocated to the customer for later allocation to one or more third party beneficiaries or for reward for the customer themselves.

With reference to FIG. 7, a flowchart describing the steps used to receive the registration or sign up of a third party beneficiary are illustrated. Processing starts at S7-1 and immediate proceeds to Step S7-2 where a representative of a beneficiary or potential beneficiary logs onto the website served by a central controller using web browser software such as Google Chrome or Internet Explorer.

After accessing the central controller, previously registered beneficiaries will be prompted to enter their credentials. A potential beneficiary or representative acting for the potential beneficiary will be prompted to supply information included but not limited to name, email address, other alternative contact information such as address, web site, social media identifiers, logo, names of authorized representatives, and telephone number or numbers which are stored in the Beneficiary database 144 along with appropriate approval status. In an alternate embodiment, the beneficiary may register or may have registered by some alternative process that gathers all or some of the required information. Examples of alternative processes include paper forms and interviews including related data entry by a customer service representative.

Proceeding to step S7-3, the system determines if the beneficiary accessing the system has previously been approved. If the beneficiary accessing the system has not been approved then the system prompts the user for required information at step S7-5.

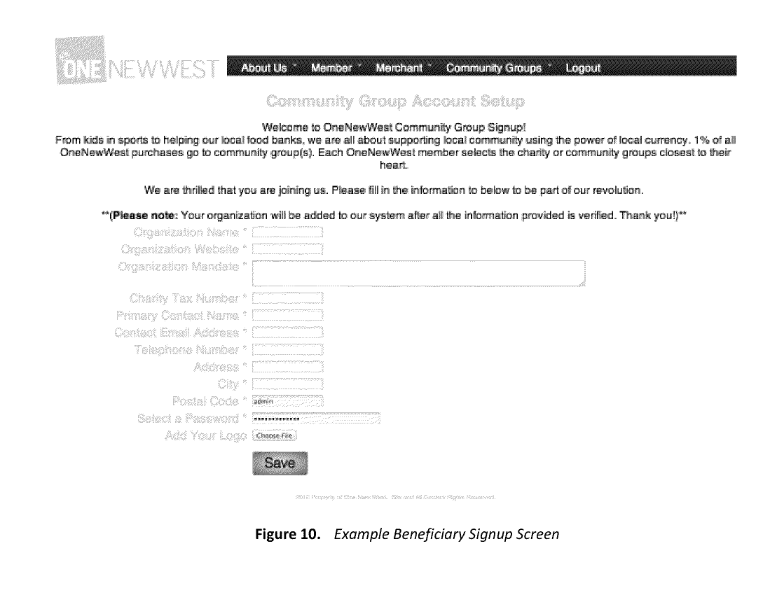

Proceeding to step S7-5, the beneficiary or representative acting for the beneficiary will be prompted for information needed to determine if the beneficiary meets the requirements for approval. An example of this user interaction is provided in FIG. 10.This information may include but is not limited to charitable organization identifier and references and will vary from embodiment to embodiment. Such information is stored in the Beneficiary database 144 and is referred to as the beneficiary's profile.

Proceeding to step S7-6, the system determines if the beneficiary meets the requirements to be approved to be made available for display to customers of this system and potentially receive benefits from customers as they transact purchases with merchants. Approval process specifics will be system implementation specific possibly involving interaction with other systems via communications networks such as the Internet. In one embodiment, the approval process may be completely automated by the system. In other embodiments, the approval process may be partially or completely manual and involve a person with appropriate domain knowledge and skills.

Proceeding to step S7-7, if system determines that the beneficiary requesting approval does not meet established requirements, the system will send appropriate notification to the beneficiary organization and associated users. Such notification will occur typically in electronic form such as email. Notification history will be stored in the Beneficiary database 144.

Proceeding to step S7-8, in the event the system determines the beneficiary meets the requirements for approval, beneficiary information in beneficiary database 144 is updated along with approval status and this beneficiary is made available to customers of the system to include in their beneficiary rewards rules.

Proceeding to step S7-9, the system will send appropriate notification of approval to the beneficiary organization, representatives associated with the beneficiary, as well as optionally other system constituents including merchants and customers. Such notification will occur typically in electronic form such as email. Notification history will be stored in the Beneficiary database 144.

Returning to step S7-3, if the beneficiary accessing the system has previously been approved then the system inform prompts the beneficiary representative who is prompted to determine if changes to the required information in the beneficiary's profile are requested at step S7-4. If so, then the process proceeds to step S7-5 as previously described.

With reference to FIG. 8, a flowchart describing the steps used to assign rewards or benefits to specific beneficiaries according to rules established by the customer in advance of the customer transacting purchases at a merchant are illustrated. Processing starts at S8-1 and immediate proceeds to Step S8-2 where customer pays for a product or service using some form of electronic payment processing system. The customer may be physically present at a merchant location, at another location where representatives of the customer and the merchant are present such as the customer's home or work site or at some remote location using some form of communications technology to interact with the merchant.

Customer identification information is received by the merchant's payment processing system or device. In the case of physical presence, this typically involves a device at the point of sale capable of reading the customer identification in whatever form they are presented including magnetic strip, some form of biometric such as a finger print, 1 or 2 dimensional bar codes either in physical form or presented electronically on a screen such as a smartphone or table screen that the customer may have, or other electronic form including near field communications, WiFi 802.11 or other wireless technology such as Bluetooth or any combination of these. In the case where the customer is interacting with the merchant over some communications network such as the Internet, the customer's identification and credentials are transmitted to the merchant either through the customer entering information manually such as manual entry of a credit card and associated information or through some capability where the device the customer is using can transmit some form of identification such as a finger print image or information previously stored in the customer's device or accessed from another location at the current or prior direction of the customer such as some form cloud storage for payment processing credential information. In either case, transaction information including the customer identification, the customer's associated payment credentials, as well as details about the actual purchase transaction including the amount of purchase, as well as merchant identifier along with optional information such as a description of the item purchased are transmitted to the Central Server using some form of communications network such as the Internet in a manner with appropriate security.

Proceeding to step S8-4, the customer identification, the customer's associated payment credentials, as well as details about the actual purchase associated with the transaction including but not limited to merchant identification and purchase price are received by the Central Server over some form of communications network such as the Internet or a private network capable of sending payment transaction information. The arrangement and configuration of the Central Controller and the compatible mechanism to receive customer identification and related credentials and transmit payment transaction details from the point of sale will be readily understood by those skilled in the area of electronic payment processing systems and information technology.

Proceeding to step S8-5, all information pertaining to the payment transaction is stored by the Central Controller in Transaction Database 141. The arrangement and configuration of the Central Controller to receive and appropriately handle accomplish this task will be well known to those skilled in the area of transaction processing and database technology.

Proceeding to step S8-6, the system determining if the customer associated with the transaction is known to the Central Controller for the purposes allocating rewards or benefits based a set of rules pre established by the customer. In one embodiment of the system, the identifier of the customer associated with the transaction may not be known to the Central Controller responsible for allocation of per transaction benefits or rewards management but may be known to the overall payment processing system that contains the Central Controller function.

Proceeding to step S8-7, the system determines if the customer associated with the transaction has established beneficiary rules that apply to this transaction. The customer may be known to the Central Controller but the customer may not have established rules. In another case the customer may have established rules which exclude this transaction from providing benefits or rewards to third parties.

Proceeding to step S8-8, the Central Controller updates information associated with the transaction according to rules specified by the customer. This includes updating the benefits database to record benefits or rewards. Amount of benefit available on per transaction is established by system and depending on the embodiment can vary based on time of day, week, or month. Amount of benefit may also vary based on merchant where some merchants are chose to allow more of the transaction to be available to the customer to assign as benefit or reward to qualified beneficiaries and/or more choose to accelerate benefits to a particular qualified beneficiary. It should be appreciated that the types of rules that may be applied are widely varied based on time, merchant, location, prior transactions, type of purchase, amount of purchase, frequency of purchase amount, among other factors or combinations of two or more factors.

Proceeding to step S8-9, information associated with benefits accrual is made available in the central controller for display and possible notification according to the beneficiary's profile. This benefits information is available to the beneficiary, the customer that assigned the benefits, as well as the merchant who contributed the benefit as well as to the Central Controller. The customer, merchant, or beneficiary can access this information from the Central Controller using a computer, laptop, tablet, smartphone or other mobile device after presenting their credentials to the Central Controller. The beneficiary or representative associated with the beneficiary may chose to be notified on a per transaction basis, after a certain number of transactions, after a certain amount of benefits assignment or accrual, periodically such as on an hourly, daily, or weekly basis. The customer may chose to be notified on a per transaction basis, after a certain number of transactions, after a certain amount of benefits assignment or accrual, periodically such as on an hourly, daily, or weekly basis. The merchant or representative associated with the merchant may chose to be notified on a per transaction basis, after a certain number of transactions, after a certain amount of benefits assignment or accrual, periodically such as on a hourly, daily, or weekly basis. Notification can occur in one or more of the following forms including regular mail, fax, email, text message, or other form of messaging such as social media including but not limited to services such as Twitter, Facebook, Yammer, or LinkedIn.

Proceeding to step S8-11, the electronic payment system executes the transaction in the conventional manner. This includes checking for sufficient funds as in the case of a debit, loyalty or stored value card or credit as in the case of a credit card, checking to ensure the customer's account is active and not suspended for administrative reasons including but not limited to fraud, lost or stolen identification, or inactivity.

Depending on the embodiment, conventional processing may occur that the start of the enhanced payment processing sequence after step S8-1 or at any stage in the described transaction handling sequence.

Proceeding to step S8-12, the status of the transaction specifically whether it was success or unsuccessful and optionally a reason why if unsuccessful is returned by the Central Controller to the point of sale payment processing device in the conventional manner.

Proceeding to step S8-13, the transaction is completed between the merchant and the customer at the point of sale.

In view of the foregoing discussions pertaining to the flowchart illustrated in FIGS. 6-8, it will be understand that a system such as system 60 enables operator of an electronic payment process system to offer its customers a personalized rewards or benefits allocation program based on their specific interests and preferences. Rewards or benefits are allocated upon purchase thereby eliminating time lapse between purchase and benefit and enabling immediate notification to all involved parties, that is the customer, the merchant, and the beneficiary or beneficiaries. As such, the customer is made aware of the impact of their purchase, merchants become directly involved in supporting beneficiaries chosen by their clientele, and beneficiaries receive contributions in an automated fashion. This new paradigm for achieving customer loyalty will benefit merchants, beneficiaries, the operators of payment processing systems as well as customers in ways not heretofore realized.

Accordingly, while this invention has been described with reference to the illustrative embodiments, this description is not intended to be construed in any limiting sense. Various modifications of the illustrative embodiments, as well as other embodiments of the invention, will be apparent to persons skilled in the art upon reference to this description.

We claim:

1. A method of dynamically allocating benefit associated with a purchase or other financial transaction:
identifying the customer and merchant in a purchase or other financial transaction; allocating benefits or incentives associated with the transaction to one or more third party beneficiaries according to rules; optional notifying of benefit allocation to all involved parties including merchant and customer; collecting and distributing of allocated benefits to designated third party beneficiaries.

2. The method in claim 1 wherein the processing of the financial transaction is accomplished by a credit card network as described in paragraph 4.

3. The method in claim 1 wherein the processing of the financial transaction is accomplished by a debit card network as described in paragraph 5.

4. The method in claim 1 wherein the processing of the financial transaction is accomplished by an alternative existing payment network.

5. The method in claim 1 wherein the processing of processing of the financial transaction is accomplished by a new payment network.

6. The method in claim 1 wherein the processing of the financial transaction is accomplished with an existing or new stored value card network.

7. The method in claim 1 wherein the allocation of benefit or incentive associated with the transaction is defined by the merchant.

8. The method in claim 1 wherein the allocation of benefit or incentive associated with the transaction is defined by the payment processing network.

9. The method in claim 1 wherein the allocation of benefit or incentive associated with the transaction is defined by a combination of both the payment processing network and the merchant itself.

10. The method in claim 1 wherein the allocation of benefit or incentive associated with the transaction is allocated to one or more beneficiaries based on rules defined by the customer.

11. The method in claim 1 wherein the allocation of benefit or incentive associated with the transaction is allocated to one or more beneficiaries based on rules defined by the customer and the merchant.

12. The method in claim 1 wherein the allocation of benefit or incentive associated with the transaction is allocated to one or more beneficiaries based on rules defined by the customer and the merchant.

13. The method in claim 1 wherein the notification of the benefit allocation to the customer, merchant, and/or beneficiary is accomplished by email.

14. The method in claim 1 wherein the notification of the benefit allocation is accomplished by enhancing information presented on the paper or electronic receipt provided to the customer.

15. The method in claim 1 wherein the notification of the benefit allocation to the customer, merchant, and/or beneficiary is accomplished by some form of social media such as Twitter.

16. The method in claim 1 wherein the notification of the benefit allocation to the customer, merchant, and/or beneficiary is accomplished by means of an application running on a mobile device such as an Apple iPhone.

17. The method in claim 1 wherein the notification of the benefit allocation to the customer, merchant, and/or beneficiary is pushed to the user by one of more electronic means based on defined preferences.
